(19) United States
(12) Patent Application Publication
(10) Pub. No.: US 2023/0090514 A1
(43) Pub. Date: Mar. 23, 2023

(54) LITHIUM METAL SECONDARY BATTERY AND ELECTROLYTIC SOLUTION

(71) Applicant: HONDA MOTOR CO., LTD., Tokyo (JP)

(72) Inventors: Tomohiro KINOSHITA, Saitama (JP); Taku OWADA, Saitama (JP)

(21) Appl. No.: 17/932,284

(22) Filed: Sep. 14, 2022

(30) Foreign Application Priority Data
Sep. 21, 2021 (JP) 2021-153062

(51) Int. Cl. H01M 10/0569; H01M 10/0525

(52) U.S. Cl. CPC H01M 10/0569; H01M 10/0525; H01M 2300/0034

(57) ABSTRACT

Provided is a lithium metal secondary battery, including: a positive electrode; a negative electrode; and an electrolyte composition between the positive and negative electrodes, the positive electrode including: a positive electrode current collector; and a positive electrode material mixture layer including a lithium composite oxide, the negative electrode including a negative electrode current collector, the electrolyte composition including dimethyl carbonate and lithium bis(fluorosulfonyl)imide, in which the molar ratio of dimethyl carbonate to lithium bis(fluorosulfonyl)imide is 1.0 or more and 3.0 or less.

This application is based on and claims the benefit of priority from Japanese Patent Application Mo. 2021-153062, filed on 21 Sep. 2021, the content of which is incorporated herein by reference.

### BACKGROUND OF THE INVENTION

### Field of the Invention

The present invention relates to a lithium metal secondary battery and an electrolytic solution.

### Related Art

Electric vehicles have drawn increased attention due to the need to reduce CO₂ emissions in view of climate-related disasters. Electric vehicles have secondary batteries installed therein. For example, lithium metal secondary batteries have been studied for installation into electric vehicles as they have high energy density.

A known lithium metal secondary battery includes, for example, a positive electrode including a positive electrode current collector and a positive electrode material mixture layer including a lithium composite oxide; a negative electrode including a negative electrode current collector and a lithium metal layer; and a separator impregnated with an electrolytic solution.

A known example of the electrolytic solution includes propylene carbonate (PC), ethyl methyl carbonate (EMC), dimethyl carbonate (DMC), a lithium salt, and lithium bis(fluorosuifonyl)iraide (LiFSI) (see Patent Document 1). This electrolytic solution includes PC, EMC, and DMC in a volume ratio of 2:4:4, has a molar ratio of LiFSI to the lithium salt of 6 to 9, and has a LiFSI concentration of 0.6 mol/L to 1.5 mol/L.

Another known example of the lithium metal secondary battery has a gel electrolyte layer including a polymer gelling agent and an electrolytic solution (see Patent Document 2).

Patent Document 1: Japanese Patent No. 5948660 Patent Document 2: Japanese Unexamined Patent Application, Publication Ho. 2018-206757

### SUMMARY OF THE INVENTION

Unfortunately, in some cases, lithium metal dendrites grow during the charge of lithium metal secondary batteries. This may result in short circuiting between the positive and negative electrodes or breakage of lithium metal dendrites and lead to a reduction in the durability of the lithium metal secondary batteries.

It is an object of the present invention to provide a lithium metal secondary battery that is less likely to suffer from the growth of lithium metal dendrites during charge.

An aspect of the present invention is directed to a lithium metal secondary battery, including: a positive electrode; a negative electrode; and an electrolyte composition between the positive and negative electrodes, the positive electrode including: a positive electrode current collector; and a positive electrode material mixture layer including a lithium composite oxide, the negative electrode including a negative electrode current collector, the electrolyte composition including dimethyl carbonate and lithium bis(fluorosulfonyl)imide, in which the molar ratio of dimethyl carbonate to lithium bis(fluorosulfonyl)imide is 1.0 or more and 3.0 or less.

The lithium metal secondary battery may further include a solid electrolyte layer between the positive and negative electrodes, in which the electrolyte composition may be provided between the positive electrode and the solid electrolyte layer.

The negative electrode may further include a lithium metal layer.

The electrolyte composition may be an electrolytic solution, and the lithium metal secondary battery may include a porous body impregnated with the electrolytic solution.

The electrolytic solution may have a viscosity of 90 mPa·s or less at 25° C.

A Raman spectrum of the electrolytic solution may have a first peak, a second peak, and a third peak, in which the first peak is derived from unsolvated dimethyl carbonate, the second peak appears due to the shift of the first peak caused by solvation of lithium ions from lithium bis(fluorosuifonyl)iraide, the intensity ratio of the second peak to the first peak is 3.5 or more/and the third peak appears at 735 cm⁻¹ or more due to the shift of a lithium bis(fluorosulfonyl)imide-derived peak caused by concentration increase-induced solvation of lithium ions.

Another aspect of the present invention is directed to an electrolytic solution including dimethyl carbonate and lithium bis(fluorosulfonyl)imide, in which the molar ratio of dimethyl carbonate to lithium bis(fluorosulfonyl)imide is 1.0 or more and 3.0 or less.

The present invention provides a lithium metal secondary battery that is less likely to suffer from the growth of lithium metal dendrites during charge.

### BRIEF DESCRIPTION OF THE DRAWINGS

FIG. 1 is a cross-sectional view of an example of a lithium metal secondary battery according to an embodiment of the present invention; FIGS. 2A and 2B are Raman spectra of an electrolytic solution of Example 1; FIGS. 3A and 3B are scanning electron microscopy (SEM) images of lithium metal deposited on a copper (Cu) foil of a lithium metal secondary battery of Example 1; FIGS. 4A and 43 are SEM images of lithium metal deposited on a Cu foil of a lithium metal secondary battery of Comparative Example 1; FIGS. 5A and 5B are SEM images of lithium metal deposited on a Cu foil of a lithium metal secondary battery of Comparative Example 2; FIG. 6 is a graph showing the relationship of voltage versus the discharge capacity of each of lithium metal secondary batteries of Example 1 and Comparative Examples 1 and 2; FIG. 7 is an optical image showing the result of observing whether lithium metal is deposited on the separator of the lithium metal secondary battery of Example 1; FIG. 8 is an optical image showing the result of observing whether lithium metal is deposited on the separator of the lithium metal secondary battery of Example 2; FIG. 9 is an optical image showing the result of observing whether lithium metal is deposited on the separator of the lithium metal secondary battery of Comparative Example 3; and FIG. 10 is a graph showing the relationship of the rate of change in peak voltage versus the second-cycle peak voltage of each of the lithium metal secondary batteries of Examples 1 and 2 and Comparative Example 3.

### DETAILED DESCRIPTION OF THE INVENTION

Hereinafter, embodiments of the present invention will be described.

The lithium metal secondary battery according to an embodiment of the present invention includes a positive electrode, a negative electrode, and an electrolyte composition between the positive and negative electrodes. The positive electrode includes a positive electrode current collector and a positive electrode material mixture layer including a lithium composite oxide. The negative electrode includes a negative electrode current collector and a lithium metal layer.

In the lithium metal secondary battery according to an embodiment of the present invention, therefore, lithium metal is deposited on the negative electrode during charge, while lithium ions dissolve from the negative electrode during discharge. Therefore, the lithium metal secondary battery according to an embodiment of the present invention may have an initial state in which the negative electrode has no lithium metal layer. In this case, the lithium metal secondary battery may be charged before use, so that lithium metal is deposited to form a lithium metal layer on the negative electrode current collector.

The electrolyte composition includes dimethyl carbonate and lithium bis(fluorosulfonyl)imide, in which the molar ratio of dimethyl carbonate to lithium bis(fluorosulfonyl)imide is 1.0 or more and 3.0 or less, and preferably 1.0 or more and 2.0 or less. In a case where the molar ratio of dimethyl carbonate to lithium bis(fluorosulfonyl)imide is less than 1.0, lithium bis(fluorosulfonyl)Imide may have low solubility in dimethyl carbonate. In a case where the molar ratio is more than 3.0, dendrites may grow during the charge of the lithium metal secondary battery to cause a reduction in the durability of the lithium metal secondary battery.

The electrolyte composition is typically, but not limited to, an electrolytic solution or a gel electrolyte.

The gel electrolyte includes an electrolytic solution and a gelling agent.

Examples of the gelling agent include, but are not limited to, PEO (polyethylene oxide)-based gelling agents, PPO (polypropylene oxide)-based gelling agents, PAN (polyacrylonitrile)-based gelling agents, PVC (polyvinyl chloride)-based gelling agents, PVdF (polyvinylidene fluoride)-based gelling agents, PMMA (poly(methyl methacrylate))-based gelling agents, PVdF-HEP (vinylidene fluoride-hexafluoropropylene copolymer)-based gelling agents, PDMS (polydimethylsiloxane)-based gelling agents, and low-molecular-weight gelling agents that: take advantage of n-n stacking.

The positive electrode current collector is typically, but not limited to, an aluminum foil.

The thickness of the positive electrode current collector is typically, but not limited to, 12 μm or more and 22 μm or less.

The positive electrode material mixture layer including the lithium composite oxide may further include an additional component.

Examples of the lithium composite oxide include, but are not limited to, [symbol] and LiFePO₄, two or more of which may be used in combination with one another.

The content of the lithium composite oxide in the positive electrode material mixture layer: is typically, but not limited to, 60% by mass or more and 96.5% by mass or less.

Examples of the additional component include a non-lithium-composite-oxide, positive electrode active material, a conductive aid, and a binder.

The thickness of the positive electrode material mixture layer is typically, but not limited to, 50 μm or more and 100 μm or less.

The negative electrode current collector is typically, but not limited to, a copper foil.

The thickness of the negative electrode current collector is typically, but not limited to, 1μm or more and 20 μm or less.

The thickness of the lithium metal layer is typically, but not limited to, 80 μm or less.

The lithium metal secondary battery according to an embodiment of the present invention may be manufactured by a known method.

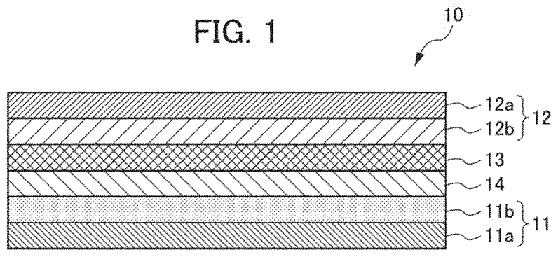

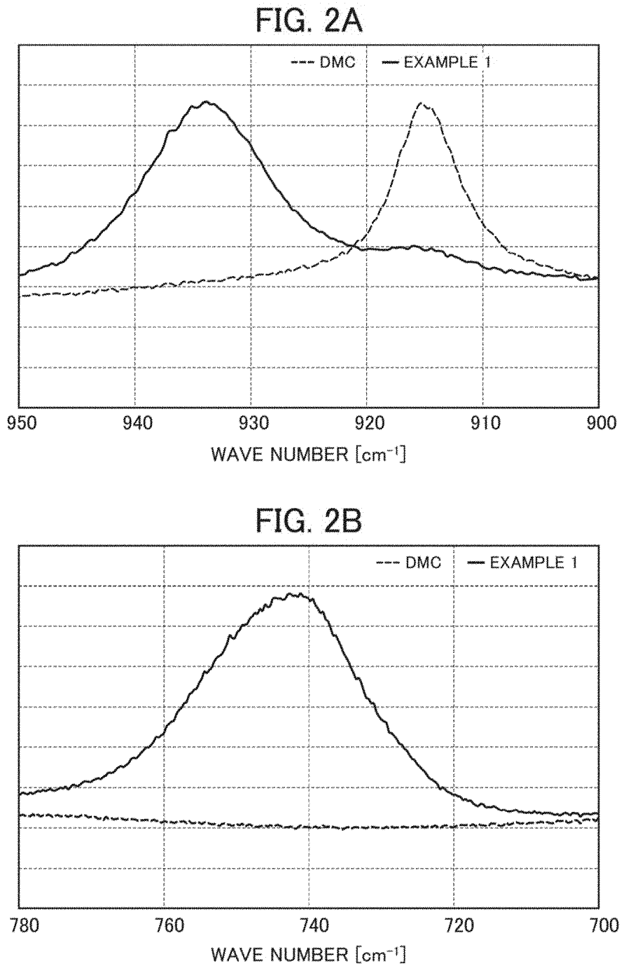

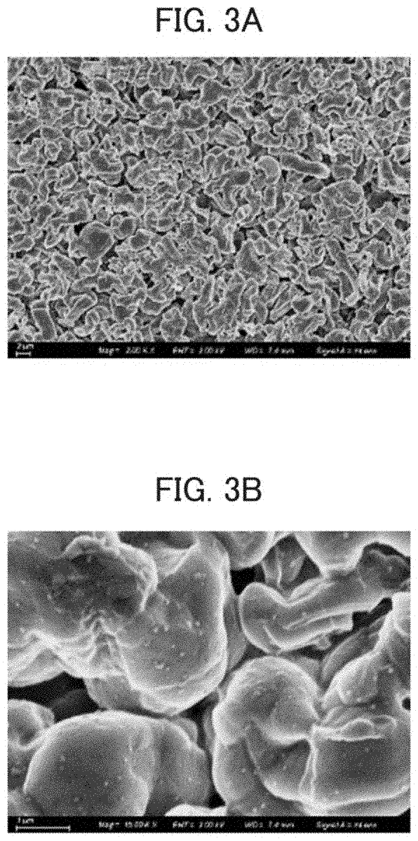

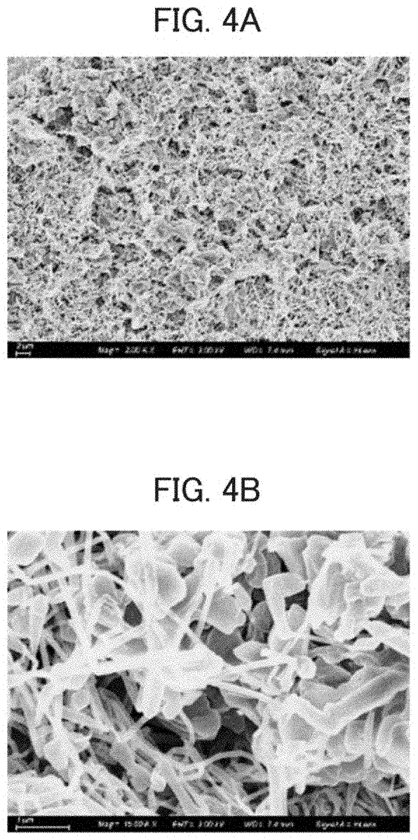

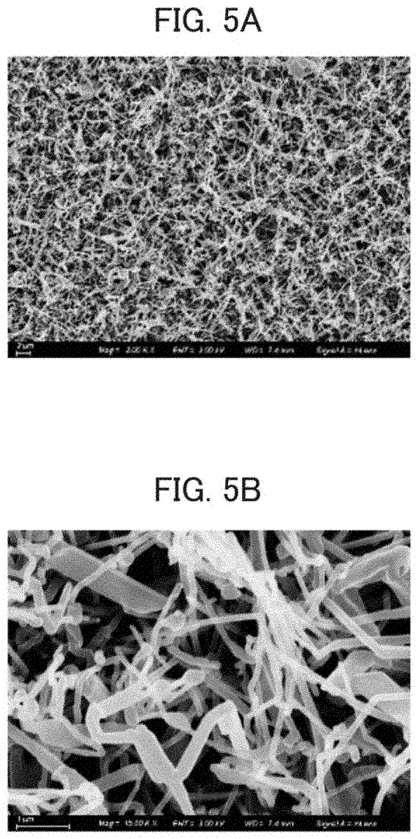

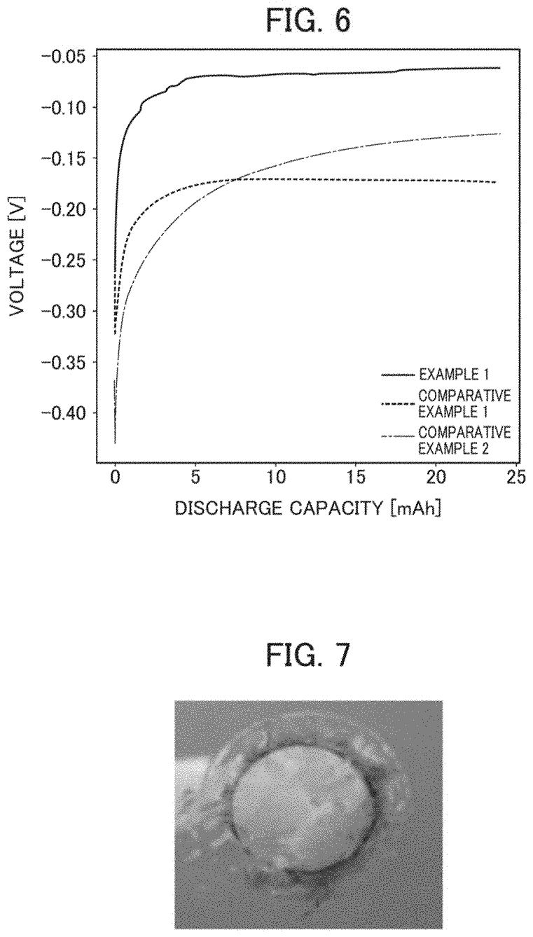

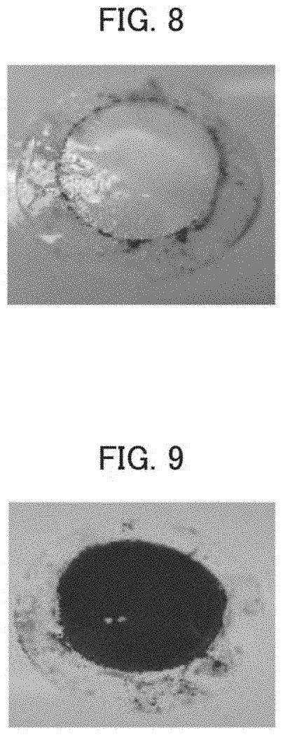

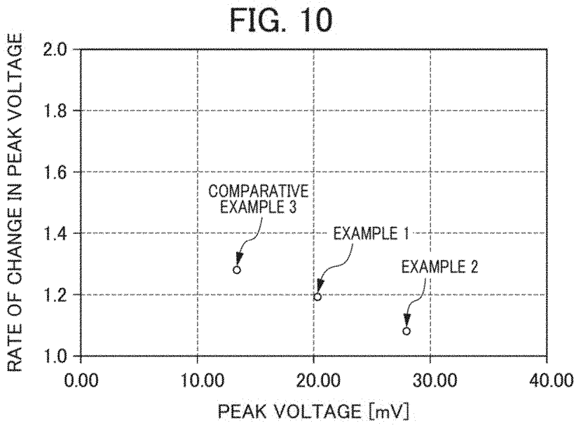

FIG. 1 shows an example of the lithium metal secondary battery according to an embodiment of the present invention.

The lithium metal secondary battery 10 includes a positive electrode 11, a negative electrode 12, a solid electrolyte layer 13 between the positive and negative electrodes 11 and 12, a porous body 14 between the positive electrode 11 and the solid electrolyte layer 13, and an electrolytic solution with which the porous body 14 is impregnated. The positive electrode 11 includes a positive electrode current collector 11a and a positive electrode material mixture layer 11b including a lithium composite oxide. The negative electrode 12 includes a negative electrode current collector 12a and a lithium metal layer 12b. The electrolytic solution includes dimethyl carbonate and lithium bis(fluorosulfonyl)iraide, in which the molar ratio of dimethyl carbonate to lithium bis(fluorosulfonyl)imide is 1.0 or more and 3.0 or less.

At 25° C., the electrolytic solution preferably has a viscosity of 90 mPa·s or less, more preferably 45 mPa·s or less. The electrolytic solution with a viscosity of 90 mPa·s or less at 25° C. tends to prevent the growth of lithium metal dendrites during high-rate charge of the lithium metal secondary battery 10.

A Raman spectrum of the electrolytic solution may have a first peak and a second peak, in which the first peak is derived from unsolvated dimethyl carbonate, and the second peak appears due to the shift of the first peak caused by solvation of lithium ions from lithium bis(fluorosulfonyl)imide. The intensity ratio of the second peak to the first peak is preferably 3.5 or more, more preferably 5.6 or more. The electrolytic solution having a Raman spectrum with an intensity ratio of the second peak to the first peak of 3.5 or more is less likely to suffer from solvent decomposition and tends to prevent the growth of lithium metal dendrites during the charge of the lithium metal secondary battery 10.

The first peak appears at around 915 cm⁻¹ like the Raman spectrum peak of dimethyl carbonate. The second peak appears at around 935 cm⁻¹.

The Raman spectrum of the electrolytic solution preferably has a third peak that appears at 735 cm⁻¹ or more due to the shift of a lithium bis(fluorosulfonyl)imide-derived peak caused by concentration increase-induced solvation of lithium ions. The third peak more preferably appears at 740 cm⁻¹ or more. The electrolytic solution having a Raman spectrum with the third peak appearing at 735 cm⁻¹ or more tends to prevent the growth of lithium metal dendrites during the charge of the lithium metal secondary battery 10.

In the Raman spectrum, the lithium bis(fluorosulfonyl)imide-derived peak appears at around 723 cm⁻¹ like the Raman spectrum peak of lithium bis(fluorosulfonyl)imide. The third peak appears at a wave number of 735 cm⁻¹ or more and 755 cm⁻¹ or less.

The solid electrolyte layer 13 may include any solid electrolyte having lithium-ion conductivity, examples of which include oxide electrolytes and sulfide electrolytes.

The thickness of the solid electrolyte layer 13 is typically, but not limited to, 5 nm or more and 20 μm or less.

The porous body 14 may be made of any suitable material. For example, the porous body 14 may be made of polyolefin, such as polyethylene or polypropylene, aramid, polyimide, fluororesin, glass fibers, or cellulose fibers.

The thickness of the porous body 14 is typically, but not limited to, 5 μm or more and 25 μm or less.

In the initial state, the negative, electrode 12 does not have, to have the lithium metal layer 12b.

The solid electrolyte layer 13 may also be omitted. In this case, the porous body 14 functions as a separator.

A gel electrolyte layer may also be used instead of the porous body 14 impregnated with the electrolytic solution. In this case, the gel electrolyte layer includes an electrolytic solution and a gelling agent.

While some embodiments of the present invention have been described, the embodiments described above are not intended to limit the present invention and may be altered or modified as appropriate without departing from the gist of the present invention.

### EXAMPLES

Hereinafter, examples of the present invention will be described, which are not intended to limit the scope of the present invention.

### Example 1

A mixture of a lithium-nickel-cobalt-manganese composite oxide (a lithium composite oxide), acetylene black (a conductive aid), and polyvinylidene fluoride (a binder) was prepared, from which a coating liquid for forming a positive electrode material mixture layer was prepared.

The coating liquid was applied to an aluminum (Al) foil (a positive electrode current collector) with a thickness of 15 μm and an area of 12 cm² and then dried to form a positive electrode material mixture layer with a density of 20 mg/cm². The product was then rolled to give a positive electrode.

A Cu foil with a thickness of 12 μm and an area of 12 cm² was used as a negative electrode current collector. A lithium fluoride material with a thickness of 10 nm and an area of 12 cm² was used as a solid electrolyte layer. A porous polyolefin film with a thickness of 20 μm and an area of 12 cm² was used as a porous body (separator).

An electrolytic solution was prepared by mixing dimethyl carbonate (DMC) and lithium bis(fluorosulfonyl)imide (LiFSI) in a molar ratio of DMC to LiFSI of 2. The electrolytic solution had a viscosity of 37.9 mPa·s at 25° C. In the Raman spectrum of the electrolytic solution, the intensity ratio of the second peak to the first peak was 5.6, and the third peak appeared at 741 cm⁻¹.

The positive electrode, the porous body, the solid electrolyte layer, and the negative electrode current collector were stacked in order. The porous body was impregnated with the electrolytic solution. Subsequently, the stack was sealed with a laminate film to form a lithium metal secondary battery.

### Example 2

A lithium metal secondary battery was prepared as in Example 1 except that the electrolytic solution was prepared so that the molar ratio of DMC to LiFSI was 1.5. The electrolytic solution had a viscosity of 89.4 mPa·s at 25° C. In the Raman spectrum of the electrolytic solution, the intensity ratio of the second peak to the first peak was 5.9, and the third peak appeared at 747 cm⁻¹.

### Comparative Example 1

A lithium metal secondary battery was prepared as in Example 1 except that propylene carbonate was used instead of DMC in the preparation of the electrolytic solution.

### Comparative Example 2

A lithium metal secondary battery was prepared as in Example 1 except that a mixture of ethylene carbonate and diethyl carbonate (in a molar ratio of 1:1) was used instead of DMC in the preparation of the electrolytic solution.

### Comparative Example 3

A lithium metal secondary battery was prepared as in Example 1 except that the electrolytic solution was prepared so that the molar ratio of DMC to LiFSI was 4. The electrolytic solution had a viscosity of 6.7 mPa·s at 25° C. In the Raman spectrum of the electrolytic solution, the intensity ratio of the second peak to the first peak was 1.9, and the third peak appeared at 732 cm⁻¹.

### Comparative Example 4

To form an electrolytic solution, dimethyl carbonate and lithium bis(fluorosulfonyl)imide were attempted to be mixed in a molar ratio of 0.9:1, but lithium bis(fluorosulfonyl)imide failed to completely dissolve in dimethyl carbonate.

### Viscosity of Electrolytic Solution

A vibrating viscometer VM-10A (manufactured by Sekonic Corporation) was used to analyze the electrolytic solution at 25° C. The density of the electrolytic solution at 25° C. was determined using a measuring flask. The viscosity of the electrolytic solution at 25° C. was determined by dividing the analytical value by the density.

Intensity Ratio of Peak Derived from DMC Solvated with LiFSI to Peak Derived from Unsolvated DMC in the Raman Spectrum of Electrolytic Solution

RAMAN-11 (manufactured by Nanophoton Corporation) was used to measure the Raman spectrum of the electrolytic solution. In the resulting Raman spectrum, the intensity ratio of the second peak to the first peak was calculated (see FIG. 2A), in which the first peak was derived from unsolvated DMC, and the second peak appeared due to the shift of the first peak caused by solvation of lithium ions from LiFSI. In the Raman spectrum, the position of the third peak was also determined (see FIG. 2B), in which the third peak appeared due to the shift of the LiFSI-derived peak caused by concentration increase-induced solvation of lithium ions. In FIGS. 2A and 2B, “DMC” indicates the Raman spectrum of DMC.

Table 1 shows the molar ratio of DMC to LiFSI in each of the electrolytic solutions of Examples 2 and 2 and Comparative Example 3 and shows the viscosity of each of the electrolytic solutions at 25° C.

TABLE 13

| | | | Raman spectrum | |
|---|---|---|---|---|
| | | | Intensity | |
| | Molar | | ratio of | Position |
| | ratio of | Viscosity | second | of third |
| | DMC to | at 25° C. | peak to | peak |
| | LiFSI | [mPa · s] | first peak | [cm⁻¹] |
| Example 1 | 2 | 37.9 | 5.6 | 741 |
| Example 2 | 1.5 | 89.4 | 5.9 | 747 |
| Comparative | 4 | 6.7 | 1.9 | 732 |
| Example 3 | | | | |

### Lithium Metal Deposition

Mounted on a jig, the lithium metal secondary battery was confined at a pressure of 0.05 MPa and then allowed to stand at the measurement temperature (25° C.) for 1 hour. Next, the lithium metal secondary battery was charged with a constant current of 60 mA. The constant-current charge was finished when the discharge capacity reached 24 mAh. In this process, lithium metal was deposited on the Cu foil to form an about 10 μm-thick lithium metal layer.

Next, a scanning electron microscope (SEM) was used to observe how the lithium metal was deposited.

FIGS. 3A and 3B, FIGS. 4A and 4B, and FIGS. 5A and 5B are SEM images showing lithium metal deposited on the Cu foil in the lithium metal secondary batteries of Example 1, Comparative Example 1, and Comparative Example 2, respectively. FIGS. 3A, 4A, and 5A are SEM images at a magnification of 2,000. FIGS. 3B, 4B, and 5B are SEM images at a magnification of 15,000.

FIGS. 3A and 3B show that the growth of lithium metal dendrites was suppressed during the charge of the lithium metal secondary battery of Example 1. FIGS. 4A and 4B and FIGS. 5A and 5B show that the growth of lithium metal dendrites occurred during the charge of the lithium metal secondary batteries of Comparative Examples 1 and 2.

FIG. 6 shows the relationship of voltage versus the discharge capacity of the lithium metal secondary battery of each of Example 1 and Comparative Examples 1 and 2.

FIG. 6 indicates that the overvoltage was lower for the lithium metal secondary battery of Example 1 than for the lithium metal secondary battery of Comparative Example 1 or 2.

### Charge-Discharge Test on Lithium Metal Secondary Battery

The discharge capacity per unit area of lithium metal was determined to be 3 mAh/cm², and a charge-discharge test was conducted under the conditions shown below. Mounted on a jig, the lithium metal secondary battery was confined at a pressure of 0.05 MPa and then allowed to stand at the measurement temperature (25° C.) for 1 hour. Next, the lithium metal secondary battery was charged with constant current at 0.2 C. The constant-current charge was finished when the capacity reached a specified value (3 mAh/cm²), when 5 hours elapsed after the start of the constant-current charge, or when the voltage reached 0.8 V. in this process, lithium metal was deposited on the Cu foil to form an about 15 μm-thick lithium metal layer. Subsequently, the battery was allowed to stand for 5 minutes. Next, the battery was discharged with constant current at 0.2 C. The constant-current discharge was finished when the capacity reached a specified value (3 mAh/cm²), when 5 hours elapsed after the start of the constant-current discharge, or when the voltage reached −0.8 V. Subsequently, the battery was allowed to stand for 5 minutes. The cycle of constant-current discharge and constant-current charge was then repeated seven times.

With respect to the specified discharge capacity per unit area of lithium metal, the current value at which the discharge was able to be completed in 1 hour corresponded to 1 C.

Next, an optical microscope was used to determine the presence or absence of a lithium metal deposition on the separator in the lithium metal secondary battery.

FIGS. 7, 8, and 9 show the optical images resulting from the determination of the presence or absence of a lithium metal deposition on the separator in the lithium metal secondary batteries of Example 1, Example 2, and Comparative Example 3, respectively.

FIGS. 7 and 8 show no lithium metal deposition on the separator in the lithium metal secondary batteries of Examples 1 and 2, which suggests that the growth of lithium metal dendrites on a large specific surface area was suppressed during the charge. FIG. 9 shows a lithium metal deposition (appearing black) on the separator in the lithium metal secondary battery of Comparative Example 3, which suggests that lithium metal dendrites grew on a large specific surface area during the charge.

FIG. 10 shows the relationship of the rate of change in peak voltage versus the second-cycle peak voltage of the lithium metal secondary battery of each of Examples 1 and 2 and Comparative Example 3. The rate of change in peak voltage was defined as the ratio of the seventh-cycle peak voltage to the second-cycle peak voltage.

FIG. 10 indicates that the lithium metal secondary battery of each of Examples 1 and 2 not only had a peak voltage higher than that of the lithium metal secondary battery of Comparative Example 3 but also exhibited a rate of change in peak voltage lower than that of Comparative Example 3, which means higher durability.

### EXPLANATION OF REFERENCE NUMERALS

10: Lithium metal secondary battery

11: Positive electrode

11a: Positive electrode current collector

11b: Positive electrode material mixture layer

12: Negative electrode

12a: Negative electrode current collector

12b: Lithium metal layer

13: Solid electrolyte layer

14: Porous body

What is claimed is:

1. A lithium metal secondary battery, comprising: a positive electrode; a negative electrode; and an electrolyte composition between the positive and negative electrodes,
the positive electrode comprising: a positive electrode current collector; and a positive electrode material mixture layer comprising a lithium composite oxide,
the negative electrode comprising a negative electrode current collector,
the electrolyte composition comprising dimethyl carbonate and lithium bis(fluorosulfonyl)imide, wherein the molar ratio of dimethyl carbonate to lithium bis(fluorosulfonyl)imide is 1.0 or more and 3.0 or less.

2. The lithium metal secondary battery according to claim 1, further comprising a solid electrolyte layer between the positive and negative electrodes, wherein
the electrolyte composition is provided between the positive electrode and the solid electrolyte layer.

3. The lithium metal secondary battery according to claim 1, wherein the negative electrode further comprises a lithium metal layer.

4. The lithium metal secondary battery according to claim 1, wherein the electrolyte composition is an electrolytic solution,
the lithium metal secondary battery including a porous body impregnated with the electrolytic solution.

5. The lithium metal secondary battery according to claim 4, wherein the electrolytic solution has a viscosity of 90 mPa·s or less at 25° C.

6. The lithium metal secondary battery according to claim 4, wherein a Raman spectrum of the electrolytic solution has a first peak, a second peak, and a third peak, wherein the first peak is derived from unsolvated dimethyl carbonate, the second peak appears due to shift of the first peak caused by solvation of lithium ions from lithium bis(fluorosulfonyl)imide, the intensity ratio of the second peak to the first peak is 3.5 or more, and the third peak appears at 735 cm⁻¹ or more due to shift of a lithium bis(fluorosulfonyl)imide-derived peak caused by concentration increase-induced solvation of lithium ions.

7. An electrolytic solution comprising: dimethyl carbonate; and lithium bis(fluorosulfonyl)imide, wherein
the molar ratio of dimethyl carbonate to lithium bis(fluorosulfonyl)imide is 1.0 or more and 3.0 or less.
